(19) United States
(12) Patent Application Publication
(10) Pub. No.: US 2026/0231281 A1
(43) Pub. Date: Aug. 6, 2026

(54) USER EQUIPMENT BEHAVIOR UNDER CELL DISCONTINUOUS TRANSMISSION/DISCONTINUOUS RECEPTION

(71) Applicant: APPLE INC., Cupertino, CA (US)

(72) Inventors: Peng Cheng, Beijing (CN); Fangli Xu, Beijing (CN); Haijing Hu, Los Gatos, CA (US); Ping-Heng Kuo, London (GB); Ralf Rossbach, Munich (DE); Sigen Ye, San Diego, CA (US); Dan Wu, Beijing (CN)

(21) Appl. No.: 19/143,736

(22) PCT Filed: Jan. 27, 2023
(86) PCT No.: PCT/CN2023/073499

§ 371 Date: Jun. 26, 2025

(51) Int. Cl. H04W 76/28

(52) U.S. Cl. CPC H04W 76/28

(57) ABSTRACT

Systems and methods related to user equipment (UE) behavior under cell discontinuous transmission (DTX)/discontinuous reception (DRX) mechanisms are disclosed herein. A UE may receive configuration information for a cell DTX/DRX pattern used by a serving cell that includes a periodicity, an offset, an active duration length of/for the cell DTX/DRX pattern, and/or UE behavior information defining one or more UE behaviors for a non-active serving cell mode. The UE may then identify a non-active duration of the cell DTX/DRX pattern during which the serving cell is in a non-active state. Finally, the UE may perform communication with the network on the first serving cell according to the non-active serving cell mode during the non-active duration of the first cell DTX/DRX pattern. Details for embodiments where the UE is further configured to use a UE connected mode DRX (CDRX) mechanism are also provided. Corresponding base station behaviors are also described.

### TECHNICAL FIELD

This application relates generally to wireless communication systems, including wireless communication systems using cell discontinuous transmission (DTX)/discontinuous reception (DRX) patterns.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a cell DTX/DRX pattern, according to embodiments herein.

FIG. 2 illustrates a first cell DTX/DRX pattern for a first cell and a second cell DTX/DRX pattern for a second cell, according to embodiments herein.

FIG. 3 illustrates a table summarizing various cases of UE behavior with respect to SPS reception when a serving cell is in a non-active duration, according to embodiments herein.

FIG. 4 illustrates a table summarizing various cases of UE behavior with respect to CG transmission when a serving cell is in a non-active duration, according to embodiments herein.

FIG. 5 illustrates a table summarizing various cases of UE behavior with respect to CG transmission when a serving cell is in a non-active duration, according to embodiments herein.

FIG. 6 illustrates a first cell DTX/DRX pattern for a first cell, a second cell DTX/DRX pattern for a second cell, and a UE CDRX pattern used by a UE, according to embodiments herein.

FIG. 7 illustrates a cell DTX/DRX pattern for a serving cell of a UE and a UE CDRX pattern used by the UE, according to embodiments herein.

FIG. 8 illustrates a cell DTX/DRX pattern for a serving cell of a UE and a UE CDRX pattern used by the UE, according to embodiments herein.

FIG. 9 illustrates a cell DTX/DRX pattern for a serving cell of a UE and a UE CDRX pattern used by the UE, according to embodiments herein.

FIG. 10 illustrates a method of a UE, according to embodiments herein.

FIG. 11 illustrates a method of a UE, according to embodiments herein.

FIG. 12 illustrates a method of a base station, according to embodiments herein.

FIG. 13 illustrates an example architecture of a wireless communication system, according to embodiments disclosed herein.

FIG. 14 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In some cases, it may be beneficial to implement one or more enhancement(s) of a cell discontinuous transmission (DTX)/discontinuous reception (DRX) mechanism. Such enhancements may implement the alignment of a cell DTX/DRX pattern with a UE DRX pattern corresponding to a radio resource control (RRC) connected (RRC_CONNECTED) mode of the UE (e.g., a UE connected mode discontinuous reception (CDRX) mode). Further, such enhancements may improve inter-node information exchange corresponding to a cell DTX/DRX mechanism. In some cases, it may be beneficial to implement such changes such that there is no change for synchronization signal block (SSB) transmission schema due to the cell DTX/DRX mechanism. Further, it may be beneficial to implement such enhancements of a cell DTX/DRX mechanism such that there is no impact to UEs in an RRC inactive mode and/or an RRC idle mode.

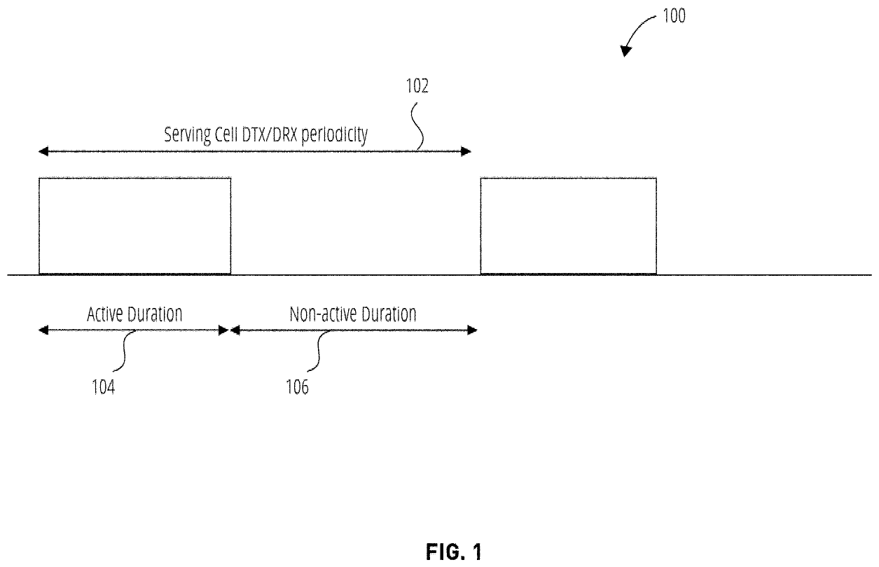

FIG. 1 illustrates a cell DTX/DRX pattern 100, according to embodiments herein. The cell DTX/DRX pattern 100 may be periodic (e.g., may repeat) according to a cell DTX/RTX periodicity 102 that incorporates a cell DTX/DRX active duration 104 during which the cell is considered to be in an active state represented by the box illustrated corresponding to the cell DTX/DRX active duration 104 (herein sometimes more simply referred to as an active duration of a cell DTX/DRX pattern) and a cell DTX/DRX non-active duration 106 (during which the cell is considered to be in a non-active state). Note that the non-active state of the serving cell may correspond to a reduced set of behavior for the serving cell (and, correspondingly, a UE communicating with the network on the serving cell) as opposed to the active state. Note that herein, the use of the terms “cell DTX/DRX pattern” and “periodic cell DTX/DRX pattern” may be understood equivalently.

Herein, a cell DTX/DRX periodicity may be referred to alternatively as a periodicity of a cell DTX/DRX pattern. Further, a cell DTX/DRX active duration may be referred to alternatively as an active duration of a cell DTX/DRX pattern. Further, a cell DTX/DRX non-active duration may be referred to alternatively as the non-active duration of a cell DTX/DRX pattern.

The cell DTX/DRX pattern 100 can be configured at a UE by a base station via UE-specific RRC signaling. The configuration of the cell DTX/DRX pattern 100 from the UE perspective may occur on a per-serving cell basis (note that in FIG. 1, the cell DTX/DRX pattern 100 is expressly described in a per-serving-cell manner). As part of this configuration, at least the following parameters can be configured: periodicity (e.g., the length of the cell DTX/RTX periodicity 102, where each such length corresponds to one period of/one periodicity within the cell DTX/DRX pattern 100), a start slot and/or start offset, and an active duration length (e.g., the length of the cell DTX/DRX active duration 104).

Further, use of a cell DTX/DRX mode (e.g., the use of the cell DTX/DRX pattern 100) can be activated and/or de-activated at the UE via any of dynamic Layer 1 (L1) signaling, dynamic Layer 2 (L2) signaling, and/or UE-specific RRC signaling. In embodiments, either and/or both of UE-specific and UE-common L1 signaling and/or L2 signaling may be used for activating/deactivating a configured cell DTX/DRX mode.

It is noted that cell DTX and cell DRX modes can be configured and operated separately in some embodiments contemplated herein. For example, there may be one RRC configuration for a cell DTX mode for the downlink (DL) direction between the UE and the serving cell. Further, there may be, either additionally or alternatively, a second RRC configuration for a cell DRX mode for the uplink (UL) direction between the UE and the serving cell. Finally, cell DTX and DRX aspects can also be configured and operated together (such that the pattern used for each of the DTX aspect and the DRX aspect is in alignment). Herein, reference to “DTX/RTX” is intended to refer to each of these possible cases, as context permits.

In some embodiments, there may be multiple base station or serving cell sleep modes that may be implemented during a non-active duration of a cell DTX/DRX pattern. In some cases, the periodic active duration/non-active duration pattern can be configured using a system information block (SIB). The different base station or serving cell sleep modes may correspond to different levels or types of base station transmission/reception behavior(s) during a non-active duration of a cell DTX/DRX pattern.

For example, in some embodiments, a base station or serving cell may use one or more of
a sleep mode 0, corresponding to base station or serving cell operation without energy saving (e.g., no non-active duration exists/is used).
a sleep mode 1, corresponding to the case where no reference signal transmission is performed (e.g., no transmission of an SSB, a channel state information reference signal (CSI-RS), and/or a tracking reference signal (TRS), etc.), is used, where there is no DL data transmission, and where there is no UL reception (including of any of UL grant, configured grant physical uplink shared channel (CG-PUSCH), random access channel (RACH), scheduling request (SR) and/or sounding reference signal (SRS)). In this case, the base station or serving cell may turn off one or more radio frequency (RF) and/or power amplifier (PA) elements during the non-active duration(s) of a cell DTX/DRX pattern.
a sleep mode 2, corresponding to a case where SSB transmission is allowed, but no DL data transmission or UL reception occurs (including UL grant, CG-PUSCH, RACH, SR and/or SRS).

The base station can activate/indicate/switch the base station or serving cell sleep mode to the UE via L1 and/or L2 signaling.

Herein, UE behavior when the UE is configured to operate with a cell DTX/DRX pattern is described for various cases. In some cases, it may be that the UE is not (also) configured to use a UE CDRX mechanism. In such cases, relevant considerations include (but are not limited to) as follows. First, UE behavior with respect to whether (or not) the UE, during a non-active duration of the cell DTX/DRX pattern, monitors for dynamic UL and/or DL grants, performs semi-persistent scheduling (SPS) reception, and/or performs transmission of one or more of a CG-PUSCH, a RACH, an SR, a RACH and/or an SRS may be considered. In such cases, the UE may be configured whether (or not) to finish an unfinished hybrid automatic repeat request (HARQ) process in some SPS/configured grant (CG) occasions during a non-active duration of a cell DTX/DRX pattern. Further, UE behavior with respect to whether (or not) to use resources scheduled by cross-carrier scheduling during a non-active duration of a cell DTX/DRX pattern may also be considered

In other cases, it may be that the UE is configured to use a UE CDRX mechanism (in addition to being configured with a cell DTX/DRX pattern for use). In such cases, relevant considerations include (but are not limited to) as follows. First, UE behavior with respect to whether (or not) to enforce alignment between the cell DTX/DRX pattern and a UE CDRX pattern used by the UE CDRX mechanism may be considered. Further, UE behavior with respect to whether (or not) the UE monitors dynamic UL/DL grants, performs SPS reception, and/or performs transmission of a CG-PUSCH, a RACH, an SR, a RACH and/or an SRS may be considered. In such cases, the UE may be configured whether (or not) to finish an unfinished HARQ process in some SPS/CG occasions during a non-active duration of a cell DTX/DRX pattern.

Persons of ordinary skill in the art will understand that while many communications discussed herein are described from the perspective of a UE, corresponding base station behavior related to these communications may also occur. For example, when the transmission and/or reception by a UE of one or more forms of signaling on a serving cell during an non-active duration of a cell DTX/DRX pattern for that serving cell occurs as described herein, it will be understood that there may be or that there is a corresponding transmission and/or reception (as the case may be) of such signaling by a base station that is broadcasting the serving cell under discussion.

Herein, UE and/or base station behavior with respect to communications on a serving cell during the non-active duration of a cell DTX/DRX pattern for that serving cell may be referred to herein as communication using and/or according to a “non-active serving cell mode”

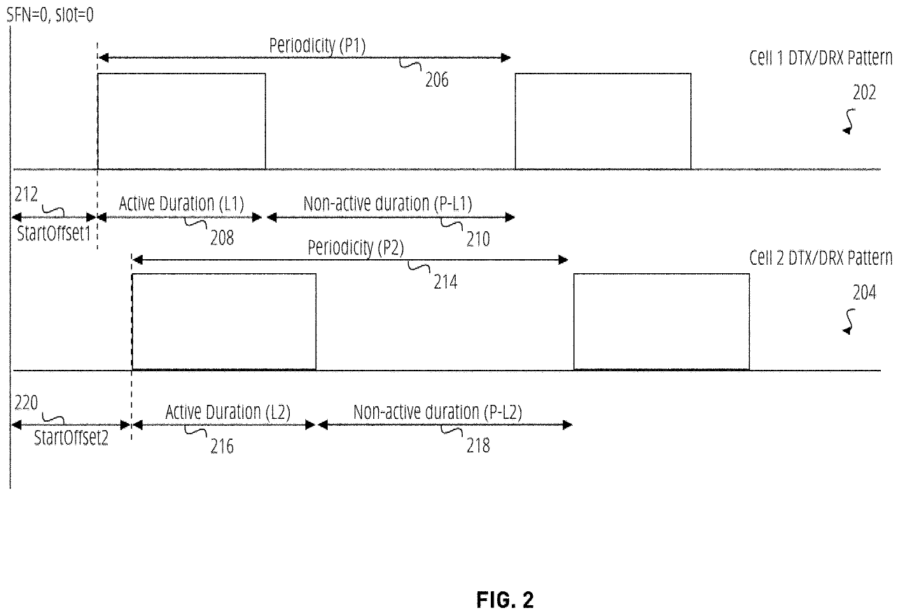

FIG. 2 illustrates a first cell DTX/DRX pattern 202 for a first cell and a second cell DTX/DRX pattern 204 for a second cell, according to embodiments herein. It is contemplated that a UE may be configured with multiple cell DTX/DRX patterns corresponding to multiple of its serving cells (e.g., in a carrier aggregation (CA) context where there are multiple cells serving the UE). Accordingly, a UE could be configured with, for example, the first cell DTX/DRX pattern 202 for use with/on a first of its serving cells and with the second cell DTX/DRX pattern 204 for use with/on a second of its serving cells.

As illustrated in FIG. 2, the first cell DTX/DRX pattern 202 operates using a first cell DTX/DRX periodicity 206, where each period of the first cell DTX/DRX periodicity 206 incorporates a first cell DTX/DRX active duration 208 and a first cell DTX/DRX non-active duration 210 of the lengths illustrated. Further, the first cell DTX/DRX pattern 202 operates beginning at a first cell DTX/DRX StartOffset 212 (that is calculated relative to slot 0 of system frame number (SFN) 0). Note that herein, a cell DTX/DRX StartOffset may be referred to alternatively as a StartOffset or an offset of a cell DTX/DRX pattern.

Further, the second cell DTX/DRX pattern 204 operates using a second cell DTX/DRX periodicity 214, where each period of the second cell DTX/DRX periodicity 214 incorporates a second cell DTX/DRX active duration 216 and a second cell DTX/DRX non-active duration 218 of the lengths illustrated. Further, the second cell DTX/DRX pattern 204 operates beginning at a second cell DTX/DRX StartOffset 220 (that is calculated relative to slot 0 of system frame number (SFN) 0).

Based on the per-serving cell-configured cell DTX/DRX periodicity and StartOffset, a start occasion of an active duration of a cell DTX/DRX pattern may be calculated using the formula

[(SFN×10)+subframe number]modulo(P)=StartOffset

(where the timing is based on a primary serving cell (PCell) when multiple cell DTX/DRX patterns corresponding to serving cells of the UE are configured). As illustrated, after the corresponding StartOffset from the beginning of the subframe, an active duration of the respective cell DTX/DRX pattern lasts for the active duration length for that cell DTX/DRX pattern (also denoted with L's in FIG. 2).

When a UE is operating in a CA context and when it is configured with multiple cell DTX/DRX patterns, various configuration alternatives for the cell DTX/DRX patterns for the different serving cells may be possible. In a first case, each of the cell DTX/DRX patterns uses an individual (e.g., different) periodicity, StartOffset, and cell active duration.

In a second case, each of the cell DTX/DRX patterns may use an individual (e.g., different) active duration, but may each use a same periodicity and StartOffset. This may correspond to a “fully overlapping” case, where the starting points of active durations for each of the different cell DTX/DRX patterns used by the different serving cells are aligned.

In a third case, each of the cell DTX/DRX patterns may use an individual (e.g., different) active duration and periodicity, while all using the same StartOffset. This may correspond to a partial overlapping case as between the different serving cells.

Note that unlike, for example, the use of an extendable inactivity timer under some UE CDRX mechanisms, an active duration of a cell DTX/DRX pattern may be fixed (may not be extendable past the configured value).

Additional details regarding embodiments for UE behavior with respect to communications on a serving cell during an active duration of a cell DTX/DRX pattern for that serving cell are now provided. It is anticipated that during an active duration of a cell DTX/DRX pattern, the UE performs normal transmit (Tx) and/or receive (Rx) behaviors (e.g., operates without reducing its feature set with respect to the state of the cell DTX/DRX pattern). These behaviors include (but are not limited to), for example; monitoring physical downlink control channel (PDCCH) for dynamic UL/DL grant so that the UE can receive/transmit a dynamic physical downlink shared channel (PDSCH)/physical uplink shared channel (PUSCH) initial transmission or retransmission; receiving SPS, paging, and/or HARQ acknowledgement (ACK)/negative acknowledgement (NACK) feedback; transmitting CG type1/type2, physical uplink control channel (PUCCH), RACH, SR, SRS, and/or HARQ ACK/NACK feedback; and/or performing measurements based on SSB and/or a configured CSI-RS.

Additional details regarding embodiments for UE behavior with respect to communications on a serving cell during a non-active duration of a cell DTX/DRX pattern for that serving cell are now provided. In some cases, in order to avoid impacting UEs operating in an RRC idle mode or an RRC inactive mode, a UE (e.g., a Release 18 (Rel-18) network energy saving (NES) capable UE) in an RRC connected mode may be configured perform various communications with a serving cell during a non-active serving cell duration at the serving cell.

For example, the UE may perform contention based random access (CBRA) messaging on the serving cell during a non-active duration on the serving cell. This may include the transmission/receipt of any of Msg1 through Msg4 of a 4-step RACH procedure and/or MsgA and/or MsgB of a 2-step RACH procedure (e.g., preamble messaging, random access response (RAR) messaging, and/or contention resolution messaging). This means, for example, that, as functional matter, the base station can transmit a RAR that includes a grant for Msg3 and Msg4 for the 4-step RACH procedure on the serving cell, and that the UE may, for example, monitor for the RAR, transmit a Msg3, and/or monitor for a PDCCH associated with Msg4 or MsgB when ra-contentionResolutionTimer is running, etc.

As another example, the UE may perform contention free random access (CFRA) messaging on the serving cell during a non-active duration on the serving cell. In such embodiments, it may be that the UE can send a CFRA preamble, perform RAR monitoring, and/or perform a UL transmission as scheduled in any RAR. Note that in alternative cases, it may be that the base station instead releases any CFRA resources before entering a non-active state, such that the UE does not perform CFRA messaging on the serving cell during the non-active duration.

As another example, the UE may monitor for paging messages/perform paging reception on the serving cell.

As another example, the UE may receive a master information block (MIB) and/or system information block (SIB) 1 (SIB1) (e.g., the UE may perform system information reception on the serving cell).

UE behavior with respect to handling of dynamic UL and/or dynamic DL grants on a serving cell corresponding to a non-active duration of the serving cell is now discussed. For a self-scheduling case (where dynamic UL and/or DL grants for the serving cell having the non-active duration are received on that same serving cell), the UE may stop monitoring for PDCCH for dynamic UL and/or DL transmission and their corresponding retransmissions on the serving cell during the non-active duration.

For a cross-carrier scheduling case (where dynamic UL and/or DL grants for the serving cell having the non-active duration are received on a second/different serving cell), it may be that a downlink control information (DCI) received from the a second/different serving cell (e.g., during an active duration of that second/different serving cell) schedules a PDSCH/PUSCH transmission during a non-active duration of the serving cell in question. In this case, various alternatives are contemplated. In a first alternative, it may be that the UE transmits the scheduled PUSCH/receives the scheduled PDSCH (even if they fall into the non-active duration of the scheduled serving cell). In a second alternative, the UE suspends the scheduled PDSCH/PUSCH if they fall into the non-active duration of the scheduled serving cell. Note that in some cases, it may be that the network should avoid the issue entirely by ensuring that any cross-carrier-scheduled PDSCH/PUSCH on the scheduled serving cell is in an active duration of the scheduled serving cell.

UE behavior with respect to SPS reception on a serving cell corresponding to a non-active duration of the serving cell is now discussed. A base station may configure the UE whether to monitor some and/or all SPS occasions corresponding to an initial SPS transmission and/or to an SPS retransmission. This means, functionally, that the UE is capable of monitoring for a PDCCH for retransmission (in addition to a capability for monitoring for a PDSCH for an initial transmission). This behavior may enable, for example, the finishing of a DL HARQ process that is still ongoing corresponding to the timing of the non-active duration.

It is contemplated that SPS occasion(s) occurring during non-active duration(s) on each serving cell may be configured with:
activated or deactivated for monitoring corresponding to an initial SPS transmission (e.g., the configuration indicates whether the UE monitors that SPS occasion for a PDSCH corresponding to an initial SPS transmission) and
activated or deactivated for monitoring for a PDCCH indicating a retransmission (e.g., the configuration indicates whether the UE monitors the SPS occasion for a PDCCH that indicates an SPS retransmission).

The configuration for the SPS occasions(s) may be provided in RRC signaling as part of UE behavior information found in configuration information for the cell DTX/DRX pattern used by the serving cell. Further, the use of the these activations/deactivations (e.g., as configured) may be dynamically indicated to one or more UE(s) via RRC signaling, L1 signaling, and/or L2 signaling.

In such circumstances, the UE may monitor activated SPS occasion for a configured initial SPS transmission and/or a PDCCH for its retransmission as configured during the non-active duration of the serving cell. In the case of SPS retransmission, the UE may receive a PDSCH in the resource indicated by a corresponding PDCCH, irrespective of whether that PDSCH is scheduled during a non-active duration of the cell DTX/DRX pattern. Further, it is noted that the UE may transmit HARQ ACK/NACK for these SPS transmissions and/or SPS retransmissions in a configured PUCCH, irrespective of whether that PUCCH is scheduled during a non-active duration of the cell DTX/DRX pattern.

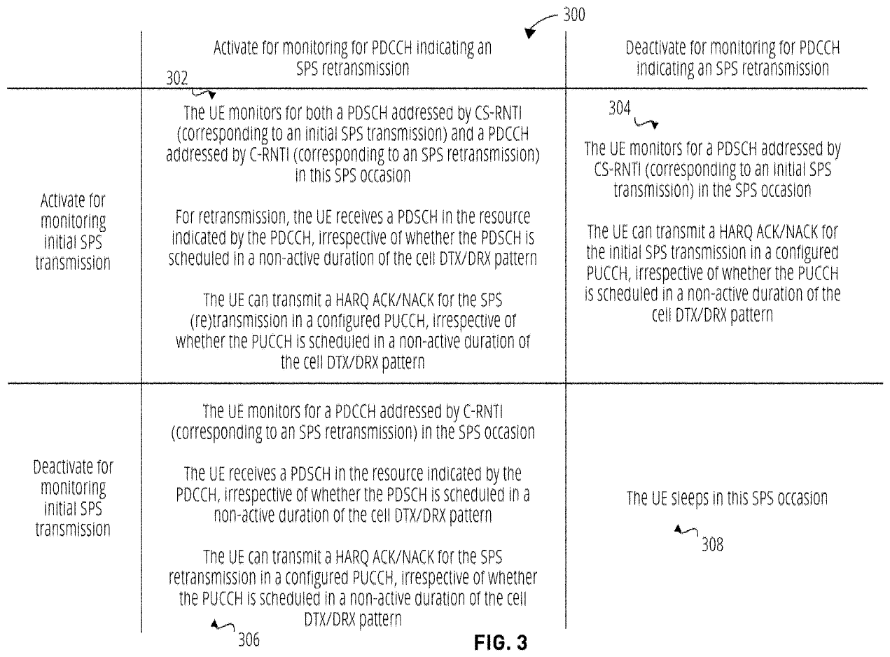

FIG. 3 illustrates a table 300 summarizing various cases of UE behavior with respect to SPS reception when a serving cell is in a non-active duration, according to embodiments herein. In a first case 302, an SPS occasion at the UE is activated for monitoring for an initial SPS transmission and is activated for monitoring for a PDCCH indicating an SPS retransmission. In the first case 302, the UE monitors for both a PDSCH addressed by a configured scheduling (CS) radio network temporary identifier (RNTI) (CS-RNTI) (corresponding to an initial SPS transmission) and for a PDCCH addressed by a cell RNTI (C-RNTI) (corresponding to an SPS retransmission). In the case of SPS retransmission, the UE receives a PDSCH in the resource indicated by the PDCCH, irrespective of whether the PDSCH is scheduled in a non-active duration of the cell DTX/DRX pattern. Further, The UE can transmit HARQ ACK/NACK for the (re) transmission in a configured PUCCH, irrespective of whether the PUCCH is scheduled in a non-active duration of the cell DTX/DRX pattern.

In a second case 304, an SPS occasion at the UE is activated for monitoring for an initial SPS transmission and is deactivated for monitoring for a PDCCH indicating an SPS retransmission. In the second case 304, the UE monitors for a PDSCH addressed by CS-RNTI (corresponding to an initial SPS transmission). Further, the UE can transmit HARQ ACK/NACK for the initial SPS transmission in a configured PUCCH, irrespective of whether the PUCCH is scheduled in a non-active duration of the cell DTX/DRX pattern.

In a third case 306, an SPS occasion at the UE is deactivated for monitoring for an initial SPS transmission and is activated for monitoring for a PDCCH indicating an SPS retransmission. In the third case 306, the UE monitors for a PDCCH addressed by C-RNTI (corresponding to an SPS retransmission). Further, the UE may receive a PDSCH in the resource indicated by the PDCCH, irrespective of whether the PDSCH is scheduled in a non-active duration of the cell DTX/DRX pattern. Finally, the UE can transmit a HARQ ACK/NACK for the SPS retransmission in a configured PUCCH, irrespective of whether the PUCCH is scheduled in a non-active duration of the cell DTX/DRX pattern.

In a fourth case 308, an SPS occasion at the UE is deactivated for monitoring for an initial SPS transmission and is deactivated for monitoring for a PDCCH indicating an SPS retransmission. The UE may sleep during this SPS occasion.

UE behavior with respect to CG transmission on a serving cell corresponding to a non-active duration of the serving cell is now discussed.

A base station may configure the UE (for some and/or all CG occasions during a non-active duration of the serving cell) whether to perform an initial CG transmission and/or whether to perform CG retransmission. The CG retransmission can be configured to either allow for PDCCH indicated retransmission (in which case the UE may monitor for a PDCCH for UL retransmission in these CG occasions) or autonomous retransmission (if otherwise allowed).

It is contemplated that CG occasion(s) occurring during a non-active duration on each serving cell may be configured with:
activated or deactivated for initial CG transmission
activated or deactivated for monitoring for a PDCCH indicating a CG retransmission, and
activated or deactivated for autonomous retransmission (in cases where autonomous retransmission is otherwise allowable)

The configuration for the CG occasion(s) may be provided in RRC signaling as part of UE behavior information found in configuration information for the cell DTX/DRX pattern used by the serving cell. Further, the use of these activations/deactivations (e.g., as configured) may be indicated to a UE via RRC signaling, L1 signaling, and/or L2 signaling.

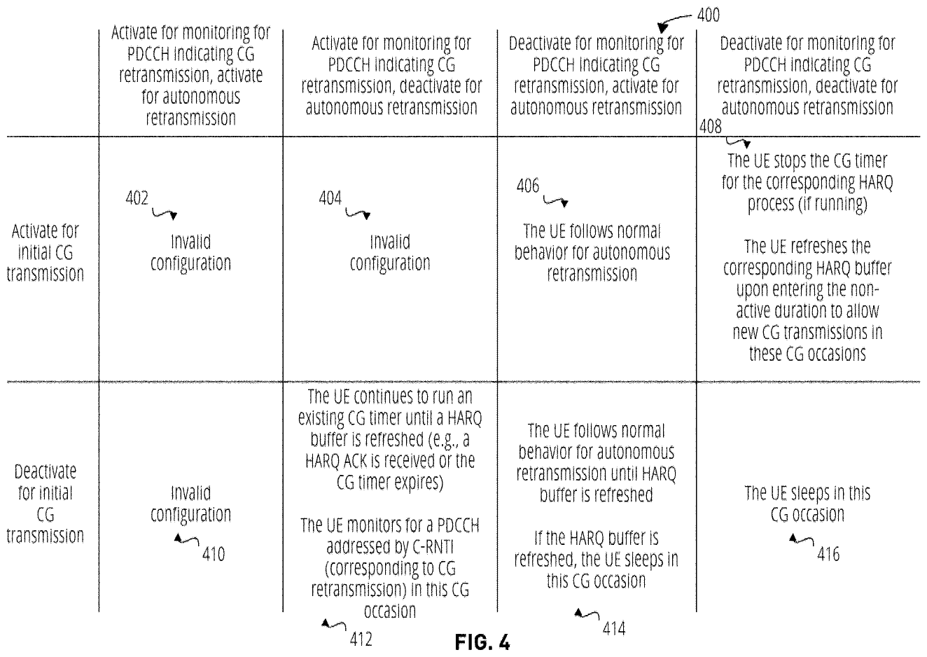

FIG. 4 illustrates a table 400 summarizing various cases of UE behavior with respect to CG transmission when a serving cell is in a non-active duration, according to embodiments herein. The table 400 corresponds to a case where autonomous retransmission is otherwise allowable in the general sense (e.g., per a system arrangement and/or configuration). Note that in such cases, it may be that both autonomous retransmission and PDCCH indicated retransmission are not activated simultaneously for the same CG occasion.

In a first case 402, a CG occasion at the UE is activated for monitoring for a PDCCH indicating a CG retransmission, activated for autonomous retransmission, and activated for an initial CG transmission. The first case 402 is an invalid case.

In a second case 404, a CG occasion at the UE is activated for monitoring for a PDCCH indicating a CG retransmission, deactivated for autonomous retransmission, and activated for an initial CG transmission. The second case 404 is an invalid case.

In a third case 406, a CG occasion at the UE is deactivated for monitoring for a PDCCH indicating a CG retransmission, activated for autonomous retransmission, and activated for an initial CG transmission. In the third case 406, the UE follows normal behavior for autonomous retransmission.

In a fourth case 408, a CG occasion at the UE is deactivated for monitoring for a PDCCH indicating a CG retransmission, deactivated for autonomous retransmission, and activated for an initial CG transmission. In the third case 406, the UE stops a CG timer for a corresponding HARQ process (if running). Further, the UE refreshes the corresponding HARQ buffer upon entering the non-active duration to allow new CG transmissions in these CG occasions.

In a fifth case 410, a CG occasion at the UE is activated for monitoring for a PDCCH indicating a CG retransmission, activated for autonomous retransmission, and deactivated for an initial CG transmission. The fifth case 410 is an invalid case.

In a sixth case 412, a CG occasion at the UE is activated for monitoring for a PDCCH indicating a CG retransmission, deactivated for autonomous retransmission, and deactivated for an initial CG transmission. In the sixth case 412, the UE continues to run an existing CG timer until a HARQ buffer is refreshed (e.g., a HARQ ACK is received or the CG timer expires). Further, the UE monitors for a PDCCH addressed by C-RNTI (corresponding to CG retransmission) in this CG occasion.

In a seventh case 414, a CG occasion at the UE is deactivated for monitoring for a PDCCH indicating a CG retransmission, activated for autonomous retransmission, and deactivated for an initial CG transmission. In the seventh case 414, the UE follows normal behavior for autonomous retransmission until HARQ buffer is refreshed. Further, if the HARQ buffer is/has been refreshed, the UE sleeps in the CG occasion.

In an eighth case 416, a CG occasion at the UE is deactivated for monitoring for a PDCCH indicating a CG retransmission, deactivated for autonomous retransmission, and deactivated for an initial CG transmission. In the eighth case 416, the UE sleeps during the CG occasion.

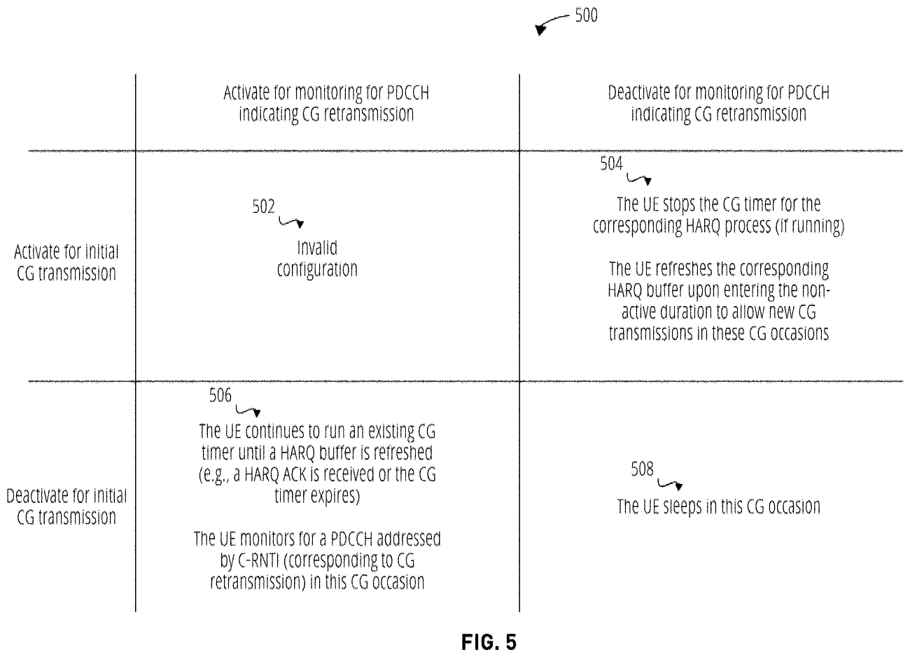

FIG. 5 illustrates a table 500 summarizing various cases of UE behavior with respect to CG transmission when a serving cell is in a non-active duration, according to embodiments herein. The table 500 corresponds to a case where autonomous retransmission not allowable in the general sense (e.g., per a system arrangement and/or configuration). The table 500 may accordingly be understood to be a simplified version of the table 400 of FIG. 4 that assumes that autonomous retransmission is not used.

In a first case 502, a CG occasion at the UE is activated for monitoring for a PDCCH indicating a CG retransmission and activated for an initial CG transmission. The first case 502 is an invalid case.

In a second case 504, a CG occasion at the UE is deactivated for monitoring for a PDCCH indicating a CG retransmission and activated for an initial CG transmission. In the second case 504, the UE stops the CG timer for the corresponding HARQ process (if running). Further, the UE refreshes the corresponding HARQ buffer upon entering the non-active duration to allow new CG transmissions in these CG occasions

In a third case 506, a CG occasion at the UE is activated for monitoring for a PDCCH indicating a CG retransmission and deactivated for an initial CG transmission. In the third case 506, the UE continues to run an existing CG timer until a HARQ buffer is refreshed (e.g., a HARQ ACK is received or the CG timer expires). Further, the UE monitors for a PDCCH addressed by C-RNTI (corresponding to CG retransmission) in this CG occasion.

In a fourth case 508, a CG occasion at the UE is deactivated for monitoring for a PDCCH indicating a CG retransmission and deactivated for an initial CG transmission. In the fourth case 508, the UE sleeps during the CG occasion.

In the case of either SPS reception and/or CG transmission as is described herein, the base station may also configure separate (new) SPS/CG occasion(s) (as the case may be) for PDCCH indicated SPS/CG retransmission(s). In such cases, the original SPS/CG occasion(s) may be configured for (e.g., only) initial SPS/CG transmission if/when they are active configured activated (e.g., these are deactivated for retransmission purposes). Then, the UE monitors for a PDCCH scheduling a SPS/CG retransmission in the new SPS/CG occasion(s) (which may be dedicated and/or reserved for such SPS/CG retransmission(s)).

UE behavior with respect to handling of SR transmissions on a serving cell during a non-active duration for the serving cell is now discussed. In some embodiments, the UE suspends transmission and/or retransmission of SRs in SR occasions occurring during the non-active duration for the serving cell.

UE behavior with respect to handling of SRS transmissions on a serving cell during a non-active duration of the serving cell is now discussed. It may be that a UE can transmit an aperiodic SRS on a serving cell during the non-active duration for the serving cell. Further, in the case of periodic and/or semi-persistent SRS, one of various of alternatives may be implemented. In a first alternative, the UE suspends transmission of periodic and/or semi-persistent SRS transmissions in all SRS occasions occurring during the non-active duration for the serving cell. In a second alternative, the UE may be configured by the base station to allow periodic and/or semi-persistent SRS transmissions in some and/or all SRS occasions occurring during the non-active duration (e.g., UE behavior information may indicate to the UE one or more semi-persistent SRSs and/or periodic SRSs are to be transmitted during the non-active duration). The use of aperiodic, periodic, and/or semi-persistent SRS transmissions as described may facilitate effective beam management between the UE and the network.

UE behavior with respect to handling of HARQ ACK/NACK transmission and/or reception on a serving cell during a non-active duration of the serving cell is now discussed. A UE may be allowed to transmit and/or receive HARQ ACK/NACK feedback during the non-active duration.

UE behavior with respect to handling of channel state information (CSI) reporting and beam management on a serving cell during a non-active duration of the serving cell is now discussed. A UE may perform normal beam measurements or relaxed measurements based on SSB and/or CSI-RS during the non-active duration if so configured by the base station. It may be that a configuration of whether (or not) to perform normal beam measurements and/or relaxed measurements in this manner may be configured by the base station via RRC signaling.

Further, the UE may perform beam management and beam failure detection (BFD) and/or beam failure recovery (BFR) based on SSB and/or CSI during the non-active duration if configured by base station.

Still further, the UE may suspend transmission of CSI in PUCCH and semi-persistent CSI in PUSCH during the non-active duration.

Still further, the UE may transmit aperiodic CSI in PUSCH during the non-active duration. This may be in anticipation of the fact that such an aperiodic CSI may have been triggered by a DCI sent to the UE at an end of an active duration and prior to the non-active duration, in which case the transmission of the aperiodic CSI may in any event still be expected to be occur (notwithstanding the entry into the non-active duration).

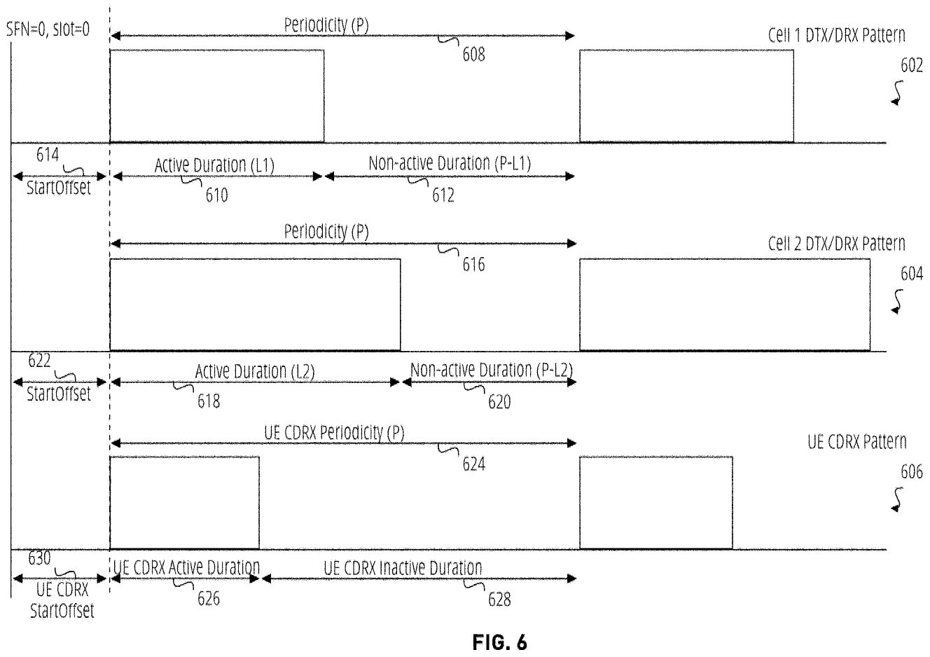

FIG. 6 illustrates a first cell DTX/DRX pattern 602 for a first cell, a second cell DTX/DRX pattern 604 for a second cell, and a UE CDRX pattern 606 used by a UE, according to embodiments herein. It is contemplated that a UE may be configured with one or more cell DTX/DRX patterns for one or more of its serving cells (e.g., may be configured with the first cell DTX/DRX pattern 602 and the second cell DTX/DRX pattern 604), in the manner described herein. Further, in some cases, the UE may also be configured to use a CDRX mechanism, during which the UE is configured to potentially change its behavior based on a UE CDRX pattern 606 that has been configured to the UE.

In FIG. 6, the first cell DTX/DRX pattern 602 operates using a first cell DTX/DRX periodicity 608 that incorporates a first cell DTX/DRX active duration 610 and a first cell DTX/DRX non-active duration 612, and that begins according to a first cell DTX/DRX StartOffset 614, in the manner that is described herein. Further, the second cell DTX/DRX pattern 604 operates using a second cell DTX/DRX periodicity 616 that incorporates a second cell DTX/DRX active duration 618 and a second cell DTX/DRX non-active duration 620, and that begins according to a second cell DTX/DRX StartOffset 622, in the manner that is described herein.

Further, the UE CDRX pattern 606 configured at the UE operates using a UE CDRX periodicity 624 that incorporates a UE CDRX active duration 626 (during which the UE behavior is not reduced per the CDRX mechanism) and a UE CDRX non-active duration 628 (during which the UE behavior may be reduced per the CDRX mechanism). This arrangement may be repeated going forward in time (through additional periods of the UE CDRX periodicity 624), as illustrated. Further, note that the UE CDRX pattern 606 begins according to a UE CDRX StartOffset 630, which may be measured from slot 0 of SFN 0, as illustrated.

Herein, a UE CDRX periodicity may be referred to alternatively as a periodicity of a UE CDRX pattern. Further, a UE CDRX active duration may be referred to alternatively as an active duration of a UE CDRX pattern. Further, a UE CDRX non-active duration may be referred to alternatively as the non-active duration of a UE CDRX pattern. Further, a UE CDRX StartOffset may be referred to alternatively as a StartOffset or an offset of a UE CDRX pattern.

Note that in FIG. 6, the presentation of the first cell DTX/DRX periodicity 608, the second cell DTX/DRX periodicity 616, and the UE CDRX periodicity 624 being of the same length is given by way of example and not by way of limitation. Similarly, the presentation of the first cell DTX/DRX StartOffset 614, the second cell DTX/DRX StartOffset 622, and the UE CDRX StartOffset 630 as being of the same length is also given by way of example and not by way of limitation.

Based on the per-serving cell-configured periodicities and StartOffsets, start occasions for an active duration for each cell DTX/DRX pattern may be calculated using the formula

$$[ ( SFN \times 10 ) + subframe number ] modulo ( P ) = StartOffset$$

(where the timing is based on a primary serving cell (PCell) when multiple cell DTX/DRX patterns corresponding to serving cells of the UE are configured, as in the case illustrated in FIG. 6). As illustrated, after the corresponding StartOffset from the beginning of the subframe, an active duration of the respective cell DTX/DRX pattern lasts for the active duration length for that cell DTX/DRX pattern (also denoted with L's in FIG. 6).

When a UE is operating in a CA context and when it is configured with multiple cell DTX/DRX patterns and it has been configured to use a UE CDRX mechanism, (e.g., as these are illustrated in FIG. 6), the network may be configured to ensure that the start timing of each active duration of each cell DTX/DRX pattern is aligned with the start timing for a CDRX active duration (e.g., at least a first such alignment relative to slot 0 of SFN 0 should be enforced). Within this constraint, various configuration alternatives for the cell DTX/DRX patterns for the different serving cells may be possible. In a first alternative, each of the cell DTX/DRX patterns may use an individual (e.g., different) active duration, but may each use a same periodicity and StartOffset. This may correspond to a “fully overlapping” case, where the starting points of active durations for each of the different cell DTX/DRX patterns used by the different serving cells are aligned. Further, if the StartOffset used is the same as the UE CDRX StartOffset used at the UE, alignment with a UE CDRX pattern used at the UE is also achieved.

In a second alternative, each of the cell DTX/DRX patterns may use an individual (e.g., different) active duration and periodicity, while all using the same StartOffset. This may correspond to a partial overlapping case as between the different serving cells. In such a case, if the StartOffset used is the same as the UE CDRX StartOffset used at the UE alignment with at least a first UE CDRX active duration at the UE (relative to slot 0 of SFN 0) is also achieved.

Note that while a length of an active duration of a cell DTX/DRX pattern may be fixed, there may be no such restraint relative to a UE CDRX active duration used by the UE CDRX mechanism. For example, in a UE CDRX mechanism a total active duration may include a first portion (e.g., corresponding to the UE CDRX active duration 626 illustrated in FIG. 6) plus an extension portion which is caused by the operation of a UE CDRX inactivity timer and/or UE CDRX retransmission timer.

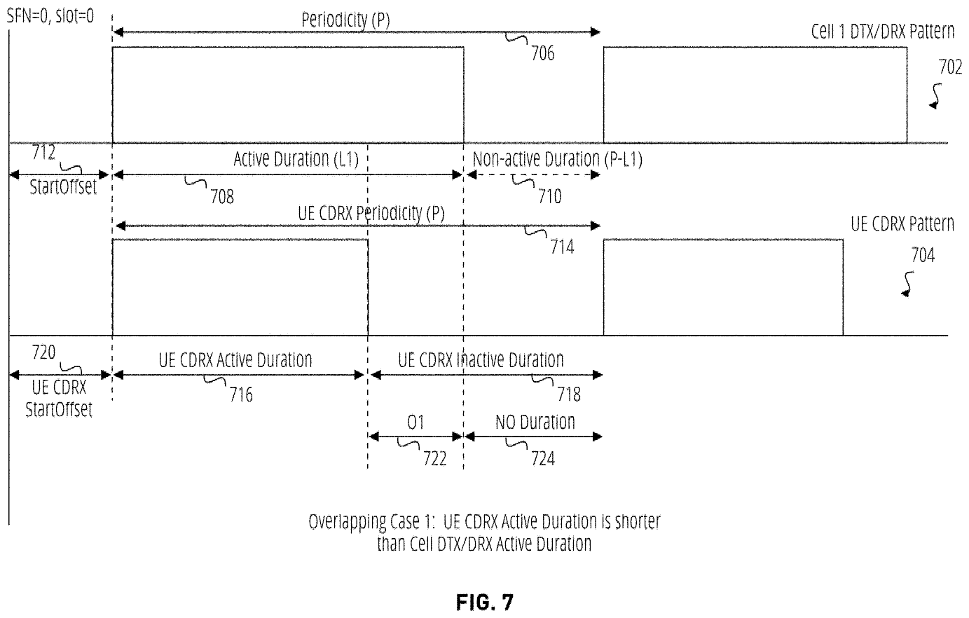

FIG. 7 illustrates a cell DTX/DRX pattern 702 for a serving cell of a UE and a UE CDRX pattern 704 used by the UE, according to embodiments herein.

In FIG. 7, the cell DTX/DRX pattern 702 operates using a cell DTX/DRX periodicity 706 that incorporates a cell DTX/DRX active duration 708 and a cell DTX/DRX non-active duration 710, and that begins according to a cell DTX/DRX StartOffset 712, in the manner that is described herein. Further, the UE CDRX pattern 704 configured at the UE operates using a UE CDRX periodicity 714 that incorporates a UE CDRX active duration 716 and a UE CDRX non-active duration 718, and that begins according to a UE CDRX StartOffset 720, in the manner described herein.

FIG. 7 illustrates a first case of an overlap as between a cell DTX/DRX pattern and a UE CDRX pattern, where (as illustrated) UE CDRX active duration 716 is shorter than the cell DTX/DRX active duration 708. This means that there is a first portion 722 of the UE CDRX non-active duration 718 that overlaps with the cell DTX/DRX active duration 708 for the cell (denoted “O1”) and that a second portion 724 of the UE CDRX non-active duration 718 corresponds instead with the cell DTX/DRX non-active duration 710 (denoted “non overlapped (NO) duration”).

It may be that during the first portion 722 of the UE CDRX non-active duration 718 that overlaps with the cell DTX/DRX active duration 708 the UE follows a specified behavior pattern corresponding to a UE CDRX inactive duration (for example, the UE may stop or cancel monitoring for PDCCHs, based on assumption that the serving cell will not send a PDCCH addressed to the C-RNTI of the UE during this period).

Then, during the second portion 724 of the UE CDRX non-active duration 718, the UE may follow the behaviors for UE operation while the serving cell is in its non-active state (e.g., may operate in a non-active serving cell mode, as has been described herein).

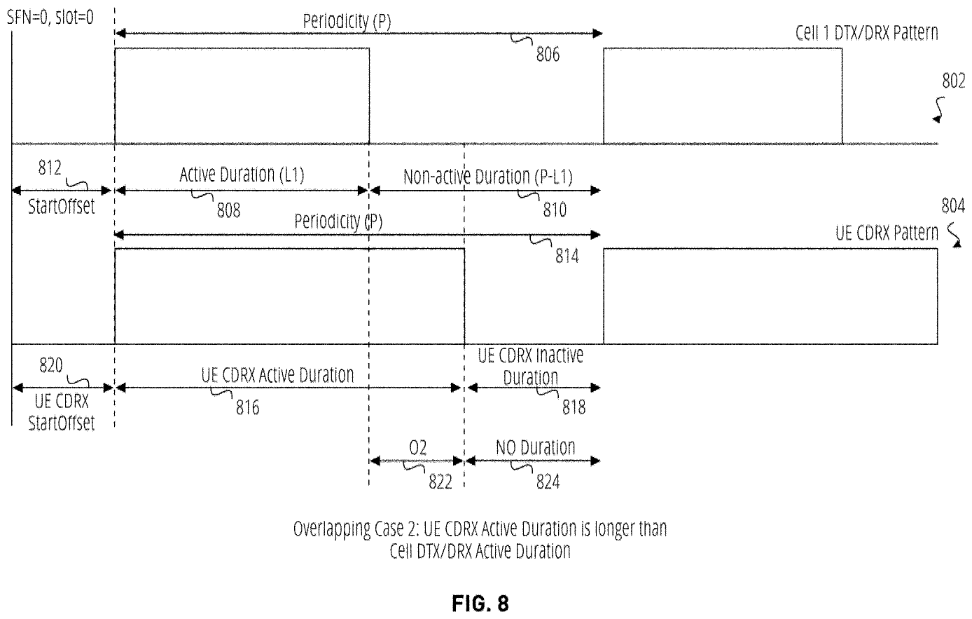

FIG. 8 illustrates a cell DTX/DRX pattern 802 for a serving cell of a UE and a UE CDRX pattern 804 used by the UE, according to embodiments herein.

In FIG. 8, the cell DTX/DRX pattern 802 operates using a cell DTX/DRX periodicity 806 that incorporates a cell DTX/DRX active duration 808 and a cell DTX/DRX non-active duration 810, and that begins according to a cell DTX/DRX StartOffset 812, in the manner that is described herein. Further, the UE CDRX pattern 804 configured at the UE operates using a UE CDRX periodicity 814 that incorporates a UE CDRX active duration 816 and a UE CDRX non-active duration 818 and that begins according to a UE CDRX StartOffset 820, in the manner described herein.

FIG. 8 illustrates a second case of an overlap as between a cell DTX/DRX pattern and a UE CDRX pattern, where (as illustrated) UE CDRX active duration 816 is longer than the cell DTX/DRX active duration 808. This means that there is a portion 822 of the UE CDRX active duration 816 that overlaps with the cell DTX/DRX non-active duration 810 for the cell (denoted “O2”) (and that a portion 824 of the UE CDRX non-active duration 818, which in this case corresponds to the entire UE CDRX non-active duration 818, is fully within the cell DTX/DRX non-active duration 810 (note that this portion 824 is denoted “NO duration”)).

During the portion 822 of the UE CDRX active duration 816 that overlaps with the cell DTX/DRX non-active duration 810, the UE may first stop and/or cancel all running CDRX timers (including an on-duration timer, an inactivity timer, a retransmission timer, and/or a round trip time (RTT) timer). Further, the UE may follow the behaviors for UE operation while the serving cell is in its non-active state (e.g., operate in a non-active serving cell mode, as has been described herein).

Alternatively, the network may be configured such that this type of overlapping (where a portion of a UE CDRX active duration overlaps with the cell DTX/DRX non-active duration) does not occur.

Finally, during the portion 824 of the UE CDRX non-active duration 818 within that is within the cell DTX/DRX non-active duration 810 (which in this case is the entire UE CDRX non-active duration 818), the UE may follow the behaviors for UE operation while the serving cell is in its non-active state (e.g., may operate in a non-active serving cell mode, as has been described herein).

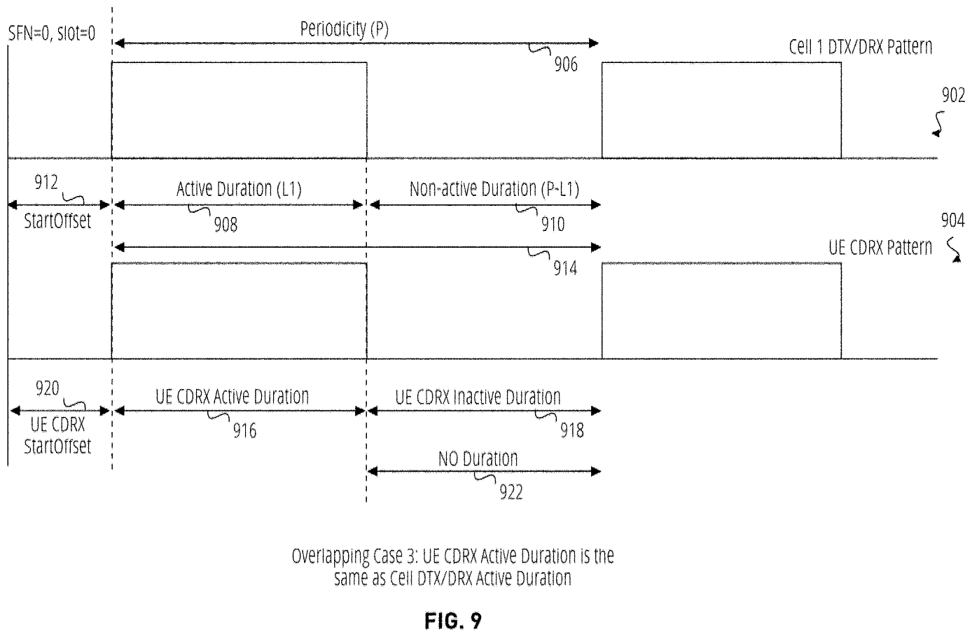

FIG. 9 illustrates a cell DTX/DRX pattern 902 for a serving cell of a UE and a UE CDRX pattern 904 used by the UE, according to embodiments herein.

In FIG. 9, the cell DTX/DRX pattern 902 operates using a cell DTX/DRX periodicity 906 that incorporates a cell DTX/DRX active duration 908 and a cell DTX/DRX non-active duration 910, and that begins according to a cell DTX/DRX StartOffset 912, in the manner that is described herein. Further, the UE CDRX pattern 904 configured at the UE operates using a UE CDRX periodicity 914 that incorporates a UE CDRX active duration 916 and a UE CDRX non-active duration 918 and that begins according to a UE CDRX StartOffset 920, in the manner described herein.

FIG. 9 illustrates a third case of an overlap as between a cell DTX/DRX pattern and a UE CDRX pattern, where (as illustrated) UE CDRX active duration 816 is the same as/is co-extensive with the cell DTX/DRX active duration 808. Further, there is a portion 922 of the UE CDRX non-active duration 918, which in this case corresponds to the entire UE CDRX non-active duration 918, that is fully within the cell DTX/DRX non-active duration 910 (note that this (entire) portion 922 is denoted “NO duration”). In this case, during the (portion 922 of) the UE CDRX non-active duration 918, the UE may follow the behaviors for UE operation while the serving cell is in its non-active state (e.g., operate in a non-active serving cell mode, as has been described herein).

In each of the overlapping cases as between a cell DTX/DRX pattern and a UE CDRX pattern as described herein, if UE group-common L1 signaling, UE group-common L2 signaling, and/or a or DRX command medium access control element (MAC-CE) having configuration information and/or activation signaling for a new/different cell DTX/DRX pattern is received, the UE may first apply and/or activate the new cell DTX/DRX pattern, re-determine any relevant overlapping features as between the cell DTX/DRX pattern and a UE CDRX pattern (e.g., features of an applicable overlapping case with respect to the new cell DTX/DRX pattern as these are described herein), and then implement a corresponding UE behavior as described herein.

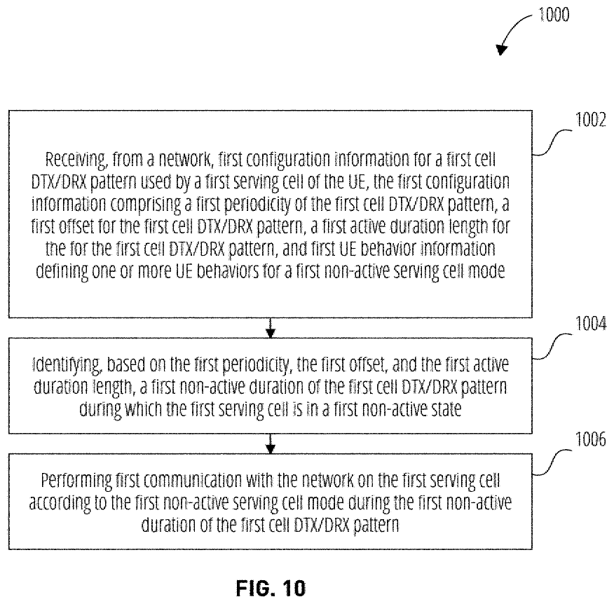

FIG. 10 illustrates a method 1000 of a UE, according to embodiments herein. The method 1000 includes receiving 1002, from a network, first configuration information for a first cell DTX/DRX pattern used by a first serving cell of the UE, the first configuration information comprising a first periodicity of the first cell DTX/DRX pattern, a first offset for the first cell DTX/DRX pattern, a first active duration length for the for the first cell DTX/DRX pattern, and first UE behavior information defining one or more UE behaviors for a first non-active serving cell mode.

The method 1000 further includes identifying 1004, based on the first periodicity, the first offset, and the first active duration length, a first non-active duration of the first cell DTX/DRX pattern during which the first serving cell is in a first non-active state.

The method 1000 further includes performing 1006 first communication with the network on the first serving cell according to the first non-active serving cell mode during the first non-active duration of the first cell DTX/DRX pattern.

In some embodiments of the method 1000, the first UE behavior information indicates, for a SPS occasion that occurs during the first non-active duration of the first cell DTX/DRX pattern, whether the UE monitors the SPS occasion for a first PDSCH corresponding to an initial SPS transmission, and whether the UE monitors the SPS occasion for a PDCCH that indicates an SPS retransmission.

In some such cases, the first UE behavior information indicates that the UE monitors the SPS occasion for the first PDSCH corresponding to the initial SPS transmission, and the first communication with the network on the first serving cell according to the first non-active serving cell mode comprises receiving the first PDSCH during the SPS occasion. In some such circumstances, the method 1000 further includes transmitting HARQ-ACK signaling to the network. In some such circumstances, the first configuration information further identifies an SPS retransmission occasion, and further comprising monitoring the SPS retransmission occasion for the PDCCH that indicates the SPS retransmission. In some such circumstances, the SPS retransmission occasion is a reserved occasion for the SPS retransmission.

In some such cases, the first UE behavior information indicates that the UE monitors the SPS occasion for the PDCCH that indicates the SPS retransmission, and the first communication with the network on the first serving cell according to the first non-active serving cell mode comprises receiving the PDCCH during the SPS occasion. In some such circumstances, the first communication with the network on the first serving cell according to the first non-active serving cell mode further comprises receiving a second PDSCH as scheduled by the PDCCH, and the method further comprises transmitting HARQ-ACK signaling to the network.

In some embodiments of the method 1000, the first UE behavior information indicates, for a CG occasion that occurs during the first non-active duration of the first cell DTX/DRX pattern, whether the CG occasion is usable by the UE for an initial CG transmission, and one or more of whether the UE monitors the CG occasions for a PDCCH that indicates a CG retransmission and whether the CG occasion is usable by the UE for an autonomous CG retransmission.

In some such cases, the first UE behavior information indicates that the CG occasion is usable by the UE for the initial CG transmission, the first communication with the network on the first serving cell according to the first non-active serving cell mode comprises using the CG occasion for the initial CG transmission, and the method 1000 further includes stopping a CG timer for a HARQ process and refreshing a HARQ buffer at a beginning of the first non-active duration of the first cell DTX/DRX pattern. In some such circumstances, the first configuration information further identifies a CG retransmission occasion; and further comprising monitoring the CG retransmission occasion for the PDCCH that indicates the CG retransmission. Further, in some such arrangements, the CG retransmission occasion is a reserved occasion for the CG retransmission.

In some such cases, the first UE behavior information indicates that the CG occasion is not usable by the UE for the initial CG transmission, the UE monitors the CG occasion for the PDCCH that indicates the CG retransmission, the first communication with the network on the first serving cell according to the first non-active serving cell mode comprises receiving the PDCCH that indicates the CG retransmission; and the method 1000 further includes running a CG timer until a HARQ buffer is refreshed.

In some such cases, the first UE behavior information indicates that the CG occasion is not usable by the UE for the initial CG transmission, the CG occasion is usable by the UE for the autonomous CG retransmission the first communication with the network on the first serving cell according to the first non-active serving cell mode comprises performing the autonomous CG retransmission during the CG occasion prior to a time that a HARQ buffer is refreshed.

In some embodiments of the method 1000, the first communication with the network on the first serving cell according to the first non-active serving cell mode comprises CBRA messaging, the CBRA messaging comprising one or more of preamble messaging, RAR messaging, and contention resolution messaging.

In some embodiments of the method 1000, the first communication with the network on the first serving cell according to the first non-active serving cell mode comprises CFRA messaging, the CFRA messaging comprising one or more of preamble messaging, RAR messaging, and transmitting a RAR-indicated PUSCH.

In some embodiments of the method 1000, the first communication with the network on the first serving cell according to the first non-active serving cell mode comprises one or more of paging reception and system information reception.

In some embodiments of the method 1000, the first communication with the network on the first serving cell according to the first non-active serving cell mode comprises one of transmitting a PUSCH on the first serving cell as scheduled by a second serving cell and receiving a PDSCH on the first serving cell as scheduled by the second serving cell.

In some embodiments of the method 1000, wherein the first communication with the network on the first serving cell according to the first non-active serving cell mode comprises one of a transmission of an aperiodic SRS and an aperiodic CSI message.

In some embodiments of the method 1000, the first UE behavior information indicates that one of a semi-persistent SRS and a periodic SRS is to be transmitted during the first non-active duration of the first cell DTX/DRX pattern, and the first communication with the network on the first serving cell according to the first non-active serving cell mode comprises a transmission of the one of the semi-persistent SRS and the periodic SRS.

In some embodiments of the method 1000, the first communication with the network on the first serving cell according to the first non-active serving cell mode comprises a transmission of HARQ feedback signaling.

In some embodiments, the method 1000 further includes, suspending one or more of a semi-persistent SRS transmission, a periodic SRS transmission, a semi-persistent CSI transmission, a periodic CSI transmission, a SR transmission, and an SR retransmission that is scheduled during the first non-active duration.

In some embodiments of the method 1000, the first UE behavior information indicates that the UE performs one of normal measurement and relaxed measurement in the first non-active serving cell mode, and the first communication with the network on the first serving cell according to the first non-active serving cell mode comprises one of first messaging corresponding to the normal measurement and second messaging corresponding to the relaxed measurement.

In some embodiments of the method 1000, the first UE behavior information indicates that the UE performs one of BFD and BFR in the first non-active serving cell mode, and the first communication with the network on the first serving cell according to the first non-active serving cell mode comprises BFR messaging, the BFR messaging comprising one or more of preamble messaging, RAR messaging, and beam recovery indication messaging.

In some embodiments of the method 1000, the first communication with the network on the first serving cell according to the first non-active serving cell mode comprises a transmission of an aperiodic CSI message.

In some embodiments, the method 1000 further includes receiving, from the network, second configuration information for a second cell DTX/DRX pattern used by a second serving cell of the UE, the second configuration information comprising a second periodicity of the second cell DTX/DRX pattern, a second offset for the second cell DTX/DRX pattern, a second active duration length for the second cell DTX/DRX pattern, and second UE behavior information defining second one or more UE behaviors for a second non-active serving cell mode, identifying, based on the second periodicity, the second offset, and the second active duration length, a second non-active duration of the second cell DTX/DRX pattern during which the second serving cell is in a second non-active state, and performing second communication with the network on the second serving cell according to the second non-active serving cell mode during the second non-active duration of the second cell DTX/DRX pattern. In some such cases, a first starting time of a first active duration of the first cell DTX/DRX pattern is equal to a second starting time of a second active duration of the second cell DTX/DRX pattern, the second periodicity of the second cell DTX/DRX pattern is equal to the first periodicity of the first cell DTX/DRX pattern, and the second offset for the second cell DTX/DRX pattern is equal to the first offset for the first cell DTX/DRX pattern.

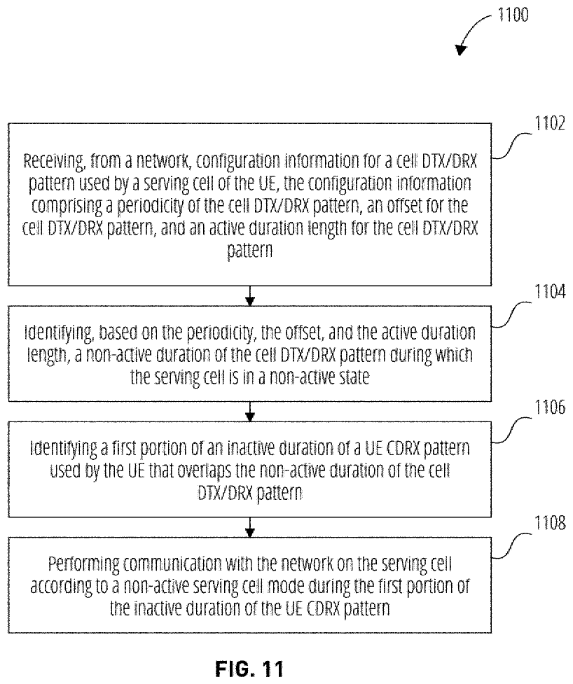

FIG. 11 illustrates a method 1100 of a UE, according to embodiments herein, the method 1100 includes receiving 1102, from a network, configuration information for a cell DTX/DRX pattern used by a serving cell of the UE, the configuration information comprising a periodicity of the cell DTX/DRX pattern, an offset for the cell DTX/DRX pattern, and an active duration length for the cell DTX/DRX pattern.

The method 1100 further includes identifying 1104, based on the periodicity, the offset, and the active duration length, a non-active duration of the cell DTX/DRX pattern during which the serving cell is in a non-active state.

The method 1100 further includes identifying 1106 a first portion of an inactive duration of a connected mode discontinuous reception (CDRX) pattern used by the UE that overlaps the non-active duration of the cell DTX/DRX pattern.

The method 1100 further includes performing 1108 communication with the network on the serving cell according to a non-active serving cell mode during the first portion of the inactive duration of the CDRX pattern.

In some embodiments of the method 1100, a first starting time of a first active duration of the first cell DTX/DRX pattern is equal to a second starting time of a second active duration of the UE CDRX pattern, the periodicity of the cell DTX/DRX pattern is equal to a UE CDRX periodicity of the UE CDRX pattern, and the offset for the cell DTX/DRX pattern is equal to a UE CDRX offset of the UE CDRX pattern.

In some embodiments, the method 1100 further includes identifying a second portion of the inactive duration of the UE CDRX pattern that overlaps with an active duration of the cell DTX/DRX pattern and stopping PDCCH monitoring during the second portion of the inactive duration of the UE CDRX pattern.

In some embodiments, the method 1100 further includes identifying a portion of an active duration of the UE CDRX pattern that overlaps with the first non-active duration of the cell DTX/DRX pattern and stopping one or more running CDRX timers during the portion of the active duration of the UE CDRX pattern, wherein the one or more CDRX timers includes one or more of an inactivity timer, a HARQ RTT timer, and a HARQ retransmission timer, wherein the communication with the network on the second serving cell according to the second non-active serving cell mode during the second non-active duration of the second cell DTX/DRX pattern is further performed during the active duration of the UE CDRX pattern.

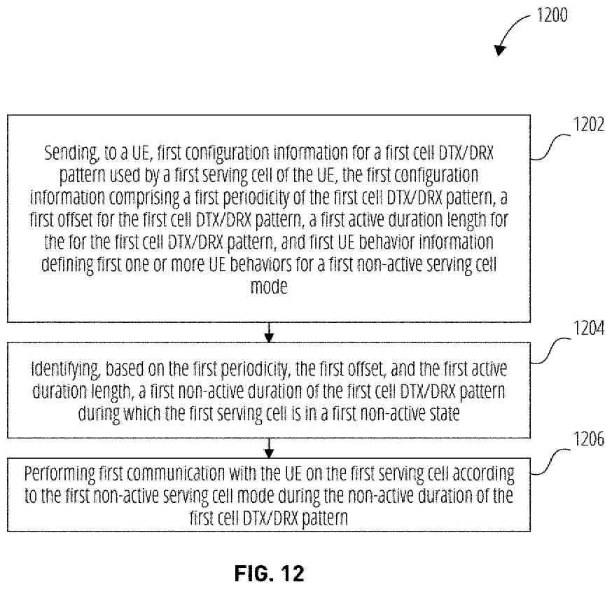

FIG. 12 illustrates a method 1200 of a base station, according to embodiments herein. The method 1200 includes sending 1202, to a UE, first configuration information for a first cell DTX/DRX pattern used by a first serving cell of the UE, the first configuration information comprising a first periodicity of the first cell DTX/DRX pattern, a first offset for the first cell DTX/DRX pattern, a first active duration length for the for the first cell DTX/DRX pattern, and first UE behavior information defining first one or more UE behaviors for a first non-active serving cell mode.

The method 1200 further includes identifying 1204, based on the first periodicity, the first offset, and the first active duration length, a first non-active duration of the first cell DTX/DRX pattern during which the first serving cell is in a first non-active state.

The method 1200 further includes performing 1206 first communication with the UE on the first serving cell according to the first non-active serving cell mode during the non-active duration of the first cell DTX/DRX pattern.

In some embodiments of the method 1200, the first UE behavior information indicates, for a SPS occasion that occurs during the first non-active duration of the first cell DTX/DRX pattern, whether the UE monitors the SPS occasion for a first PDSCH corresponding to an initial SPS transmission and whether the UE monitors the SPS occasion for a PDCCH that indicates an SPS retransmission.

In some such cases, the first UE behavior information indicates that the UE monitors the SPS occasion for the first PDSCH corresponding to the initial SPS transmission and the first communication with the UE on the first serving cell according to the first non-active serving cell mode comprises sending the first PDSCH during the SPS occasion. In some such circumstances, the method 1200 further includes receiving hybrid automatic repeat request acknowledgment (HARQ-ACK) signaling from the UE during the non-active duration. In some such circumstances, the first configuration information further identifies an SPS retransmission occasion; and further comprising sending the PDCCH that indicates the SPS retransmission during the SPS retransmission occasion. In some such circumstances, the SPS retransmission occasion is a reserved occasion for the SPS transmission.

In some such cases, the first UE behavior information indicates that the UE monitors the SPS occasion for the PDCCH that indicates the SPS retransmission, and the first communication with the UE on the first serving cell according to the first non-active serving cell mode comprises sending the PDCCH during the SPS occasion. In some such circumstances, one or more of: the first communication with the UE on the first serving cell according to the first non-active serving cell mode further comprises sending a second PDSCH as scheduled by the PDCCH, and the method further comprises receiving HARQ-ACK signaling from the UE.

In some embodiments of the method 1200, the first UE behavior information indicates, for a CG occasion that occurs during the non-active duration of the first cell DTX/DRX pattern, whether the CG occasion is usable by the UE for an initial CG transmission and one or more of: whether the UE monitors the CG occasions for a PDCCH that indicates a CG retransmission and whether the CG occasion is usable by the UE for an autonomous CG retransmission.

In some such cases, the first UE behavior information indicates that the CG occasion is usable by the UE for the initial CG transmission, and the first communication with the UE on the first serving cell according to the first non-active serving cell mode comprises receiving an initial CG transmission on the CG occasion. In some such circumstances, the first configuration information further identifies a CG retransmission occasion for the UE to monitor for the PDCCH that indicates the CG retransmission. Further, in some such arrangements, the CG retransmission occasion is a reserved occasion for the CG retransmission.

In some such cases, the first UE behavior information indicates that the CG occasion is not usable by the UE for the initial CG transmission and the UE monitors the CG occasion for the PDCCH that indicates the CG retransmission, and the first communication with the UE on the first serving cell according to the first non-active serving cell mode comprises sending the PDCCH that indicates the CG retransmission. In some such circumstances, the first UE behavior information indicates that the CG occasion is not usable by the UE for the initial CG transmission and the CG occasion is usable by the UE for the autonomous CG retransmission, and the first communication with the UE on the first serving cell according to the first non-active serving cell mode comprises receiving the autonomous CG retransmission during the CG occasion.

In some embodiments of the method 1200, the first communication with the UE on the first serving cell according to the first non-active serving cell mode comprises CBRA messaging, the CBRA messaging comprising one or more of preamble messaging, RAR messaging, and contention resolution messaging.

In some embodiments of the method 1200, the first communication with the UE on the first serving cell according to the first non-active serving cell mode comprises CFRA messaging, the CFRA messaging comprising one or more of preamble messaging, RAR messaging, and transmitting a RAR-indicated PUSCH.

In some embodiments, the method 1200 further includes releasing a CFRA resource prior to the non-active duration.

In some embodiments of the method 1200, the first communication with the UE on the first serving cell according to the first non-active serving cell mode comprises one or more of paging transmission and system information transmission.

In some embodiments of the method 1200, the first communication with the UE on the first serving cell according to the first non-active serving cell mode comprises one of receiving a PUSCH on the first serving cell as scheduled by a second serving cell and transmitting a PDSCH on the first serving cell as scheduled by the second serving cell.

In some embodiments, the method 1200 further includes sending, to the UE, a first PDCCH that schedules one of a PDSCH and a PUSCH at a scheduling time occurring during the non-active duration and on a second serving cell of the UE that is in an active state at the scheduled time.

In some embodiments of the method 1200, the first communication with the UE on the first serving cell according to the first non-active serving cell mode comprises a reception of an aperiodic SRS and an aperiodic CSI message.

In some embodiments of the method 1200, the first UE behavior information indicates that one of a semi-persistent SRS and a periodic SRS is to be transmitted during the first non-active duration of the first cell DTX/DRX pattern, and the first communication with the UE on the first serving cell according to the first non-active serving cell mode comprises a reception of one of the semi-persistent SRS and the periodic SRS.

In some embodiments of the method 1200, the first communication with the UE on the first serving cell according to the first non-active serving cell mode comprises a reception of HARQ feedback signaling.

In some embodiments, the method 1200 further includes suspending one or more of a semi-persistent SRS reception, a periodic SRS reception, a semi-persistent CSI reception, a periodic CSI reception, an SR reception, and an SR retransmission reception that is scheduled during the first non-active duration.

In some embodiments of the method 1200, the first UE behavior information indicates that the UE performs one of normal measurement and relaxed measurement in the first non-active serving cell mode, and the first communication with the UE on the first serving cell according to the first non-active serving cell mode comprises one of first messaging corresponding to the normal measurement and second messaging corresponding to the relaxed measurement.

In some embodiments of the method 1200, the first UE behavior information indicates that the UE performs one of BFD and BFR in the first non-active serving cell mode, and the first communication with the UE on the first serving cell according to the first non-active serving cell mode comprises BFR messaging, the BFR messaging comprising one or more of preamble messaging, RAR messaging, and beam recovery indication messaging.

In some embodiments, the method 1200 further includes sending, to the UE, second configuration information for a second cell DTX/DRX pattern used by a second serving cell of the UE, the second configuration information comprising a second periodicity of the second cell DTX/DRX pattern, a second offset for the second cell DTX/DRX pattern, a second active duration length for the second cell DTX/DRX pattern, and second UE behavior information defining second one or more UE behaviors for a second non-active serving cell mode, identifying, based on the second periodicity, the second offset, and the second active duration length, a second non-active duration of the second cell DTX/DRX pattern during which the second serving cell is in a non-active state, and performing second communication with the UE on the second serving cell according to the second non-active serving cell mode during the second non-active duration of the second cell DTX/DRX pattern.

In some embodiments, the method 1200 further includes determining the first offset for the first cell DTX/DRX pattern such that it is the same as a UE CDRX offset of a UE CDRX configuration used by the UE. In some such cases, the method 1200 further includes determining the first periodicity of the first cell DTX/DRX pattern such that it is the same as a UE CDRX periodicity of a UE CDRX configuration used by the UE.

In some embodiments, the method 1200 further includes determining the first active duration length for the for the first cell DTX/DRX pattern such that it is less than or equal to a UE CDRX active duration length of a UE CDRX configuration used by the UE.

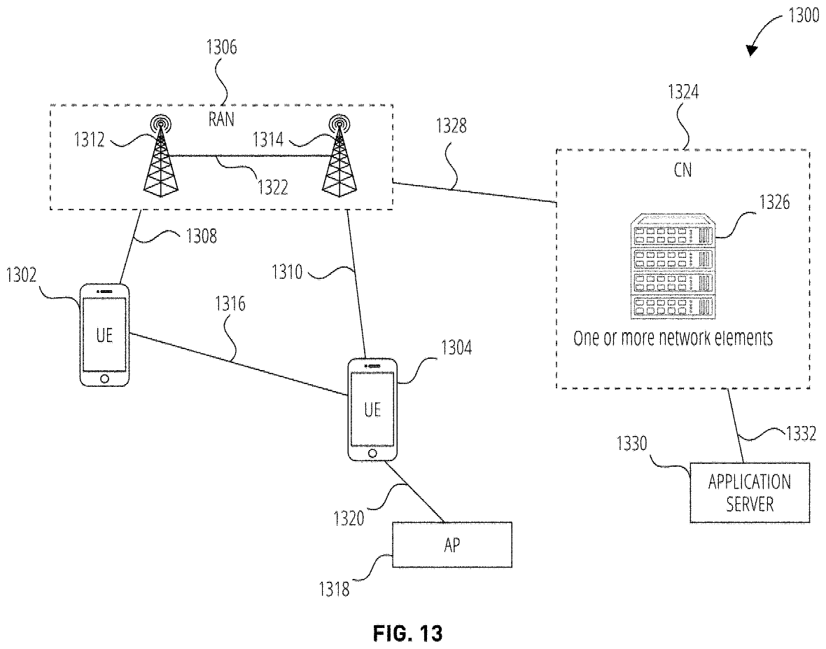

FIG. 13 illustrates an example architecture of a wireless communication system 1300, according to embodiments disclosed herein. The following description is provided for an example wireless communication system 1300 that operates in conjunction with the LTE system standards and/or 5G or NR system standards as provided by 3GPP technical specifications.

As shown by FIG. 13, the wireless communication system 1300 includes UE 1302 and UE 1304 (although any number of UEs may be used). In this example, the UE 1302 and the UE 1304 are illustrated as smartphones (e.g., handheld touchscreen mobile computing devices connectable to one or more cellular networks), but may also comprise any mobile or non-mobile computing device configured for wireless communication.

The UE 1302 and UE 1304 may be configured to communicatively couple with a RAN 1306. In embodiments, the RAN 1306 may be NG-RAN, E-UTRAN, etc. The UE 1302 and UE 1304 utilize connections (or channels) (shown as connection 1308 and connection 1310, respectively) with the RAN 1306, each of which comprises a physical communications interface. The RAN 1306 can include one or more base stations (such as base station 1312 and base station 1314) that enable the connection 1308 and connection 1310.

In this example, the connection 1308 and connection 1310 are air interfaces to enable such communicative coupling, and may be consistent with RAT(s) used by the RAN 1306, such as, for example, an LTE and/or NR.

In some embodiments, the UE 1302 and UE 1304 may also directly exchange communication data via a sidelink interface 1316. The UE 1304 is shown to be configured to access an access point (shown as AP 1318) via connection 1320. By way of example, the connection 1320 can comprise a local wireless connection, such as a connection consistent with any IEEE 802.11 protocol, wherein the AP 1318 may comprise a Wi-Fi® router. In this example, the AP 1318 may be connected to another network (for example, the Internet) without going through a CN 1324.

In embodiments, the UE 1302 and UE 1304 can be configured to communicate using orthogonal frequency division multiplexing (OFDM) communication signals with each other or with the base station 1312 and/or the base station 1314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1312 or base station 1314 may be implemented as one or more software entities running on server computers as part of a virtual network. In addition, or in other embodiments, the base station 1312 or base station 1314 may be configured to communicate with one another via interface 1322. In embodiments where the wireless communication system 1300 is an LTE system (e.g., when the CN 1324 is an EPC), the interface 1322 may be an X2 interface. The X2 interface may be defined between two or more base stations (e.g., two or more eNBs and the like) that connect to an EPC, and/or between two eNBs connecting to the EPC. In embodiments where the wireless communication system 1300 is an NR system (e.g., when CN 1324 is a 5GC), the interface 1322 may be an Xn interface. The Xn interface is defined between two or more base stations (e.g., two or more gNBs and the like) that connect to 5GC, between a base station 1312 (e.g., a gNB) connecting to 5GC and an eNB, and/or between two eNBs connecting to 5GC (e.g., CN 1324).

The RAN 1306 is shown to be communicatively coupled to the CN 1324. The CN 1324 may comprise one or more network elements 1326, which are configured to offer various data and telecommunications services to customers/subscribers (e.g., users of UE 1302 and UE 1304) who are connected to the CN 1324 via the RAN 1306. The components of the CN 1324 may be implemented in one physical device or separate physical devices including components to read and execute instructions from a machine-readable or computer-readable medium (e.g., a non-transitory machine-readable storage medium).

In embodiments, the CN 1324 may be an EPC, and the RAN 1306 may be connected with the CN 1324 via an S1 interface 1328. In embodiments, the S1 interface 1328 may be split into two parts, an S1 user plane (S1-U) interface, which carries traffic data between the base station 1312 or base station 1314 and a serving gateway (S-GW), and the S1-MME interface, which is a signaling interface between the base station 1312 or base station 1314 and mobility management entities (MMEs).

In embodiments, the CN 1324 may be a 5GC, and the RAN 1306 may be connected with the CN 1324 via an NG interface 1328. In embodiments, the NG interface 1328 may be split into two parts, an NG user plane (NG-U) interface, which carries traffic data between the base station 1312 or base station 1314 and a user plane function (UPF), and the S1 control plane (NG-C) interface, which is a signaling interface between the base station 1312 or base station 1314 and access and mobility management functions (AMFs).

Generally, an application server 1330 may be an element offering applications that use internet protocol (IP) bearer resources with the CN 1324 (e.g., packet switched data services). The application server 1330 can also be configured to support one or more communication services (e.g., VoIP sessions, group communication sessions, etc.) for the UE 1302 and UE 1304 via the CN 1324. The application server 1330 may communicate with the CN 1324 through an IP communications interface 1332.

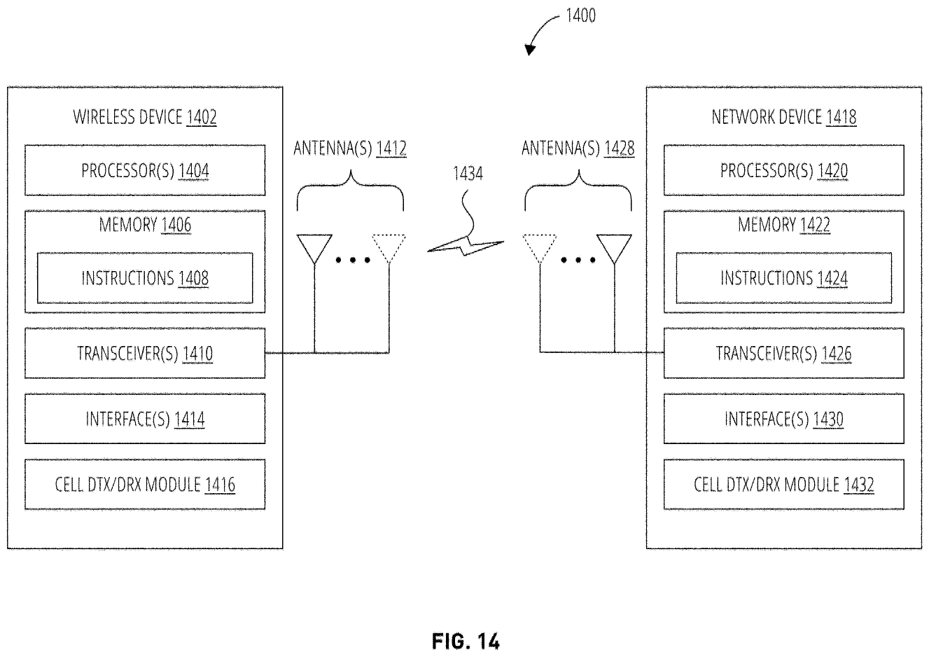

FIG. 14 illustrates a system 1400 for performing signaling 1434 between a wireless device 1402 and a network device 1418, according to embodiments disclosed herein. The system 1400 may be a portion of a wireless communications system as herein described. The wireless device 1402 may be, for example, a UE of a wireless communication system. The network device 1418 may be, for example, a base station (e.g., an eNB or a gNB) of a wireless communication system.

The wireless device 1402 may include one or more processor(s) 1404. The processor(s) 1404 may execute instructions such that various operations of the wireless device 1402 are performed, as described herein. The processor(s) 1404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1402 may include a memory 1406. The memory 1406 may be a non-transitory computer-readable storage medium that stores instructions 1408 (which may include, for example, the instructions being executed by the processor(s) 1404). The instructions 1408 may also be referred to as program code or a computer program. The memory 1406 may also store data used by, and results computed by, the processor(s) 1404.

The wireless device 1402 may include one or more transceiver(s) 1410 that may include radio frequency (RF) transmitter and/or receiver circuitry that use the antenna(s) 1412 of the wireless device 1402 to facilitate signaling (e.g., the signaling 1434) to and/or from the wireless device 1402 with other devices (e.g., the network device 1418) according to corresponding RATs.

The wireless device 1402 may include one or more antenna(s) 1412 (e.g., one, two, four, or more). For embodiments with multiple antenna(s) 1412, the wireless device 1402 may leverage the spatial diversity of such multiple antenna(s) 1412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1402 may be accomplished according to precoding (or digital beamforming) that is applied at the wireless device 1402 that multiplexes the data streams across the antenna(s) 1412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1402 may implement analog beamforming techniques, whereby phases of the signals sent by the antenna(s) 1412 are relatively adjusted such that the (joint) transmission of the antenna(s) 1412 can be directed (this is sometimes referred to as beam steering).

The wireless device 1402 may include one or more interface(s) 1414. The interface(s) 1414 may be used to provide input to or output from the wireless device 1402. For example, a wireless device 1402 that is a UE may include interface(s) 1414 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1410/antenna(s) 1412 already described) that allow for communication between the UE and other devices and may operate according to known protocols (e.g., Wi-Fi®, Bluetooth®, and the like).

The wireless device 1402 may include a cell DTX/DRX module 1416. The cell DTX/DRX module 1416 may be implemented via hardware, software, or combinations thereof. For example, the cell DTX/DRX module 1416 may be implemented as a processor, circuit, and/or instructions 1408 stored in the memory 1406 and executed by the processor(s) 1404. In some examples, the cell DTX/DRX module 1416 may be integrated within the processor(s) 1404 and/or the transceiver(s) 1410. For example, the cell DTX/DRX module 1416 may be implemented by a combination of software components (e.g., executed by a DSP or a general processor) and hardware components (e.g., logic gates and circuitry) within the processor(s) 1404 or the transceiver(s) 1410.

The cell DTX/DRX module 1416 may be used for various aspects of the present disclosure, for example, aspects of FIG. 1 through FIG. 12. For example, the cell DTX/DRX module 1416 is configured to cause the wireless device 1402 (e.g., a UE) to communicate with a network on a serving cell according to a non-active serving cell mode during a non-active duration of a serving cell of the wireless device 1402.

The network device 1418 may include one or more processor(s) 1420. The processor(s) 1420 may execute instructions such that various operations of the network device 1418 are performed, as described herein. The processor(s) 1420 may include one or more baseband processors implemented using, for example, a CPU, a DSP, an ASIC, a controller, an FPGA device, another hardware device, a firmware device, or any combination thereof configured to perform the operations described herein.

The network device 1418 may include a memory 1422. The memory 1422 may be a non-transitory computer-readable storage medium that stores instructions 1424 (which may include, for example, the instructions being executed by the processor(s) 1420). The instructions 1424 may also be referred to as program code or a computer program. The memory 1422 may also store data used by, and results computed by, the processor(s) 1420.

The network device 1418 may include one or more transceiver(s) 1426 that may include RF transmitter and/or receiver circuitry that use the antenna(s) 1428 of the network device 1418 to facilitate signaling (e.g., the signaling 1434) to and/or from the network device 1418 with other devices (e.g., the wireless device 1402) according to corresponding RATs.

The network device 1418 may include one or more antenna(s) 1428 (e.g., one, two, four, or more). In embodiments having multiple antenna(s) 1428, the network device 1418 may perform MIMO, digital beamforming, analog beamforming, beam steering, etc., as has been described.

The network device 1418 may include one or more interface(s) 1430. The interface(s) 1430 may be used to provide input to or output from the network device 1418. For example, a network device 1418 that is a base station may include interface(s) 1430 made up of transmitters, receivers, and other circuitry (e.g., other than the transceiver(s) 1426/antenna(s) 1428 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1418 may include a cell DTX/DRX module 1432. The cell DTX/DRX module 1432 may be implemented via hardware, software, or combinations thereof. For example, the cell DTX/DRX module 1432 may be implemented as a processor, circuit, and/or instructions 1424 stored in the memory 1422 and executed by the processor(s) 1420. In some examples, the cell DTX/DRX module 1432 may be integrated within the processor(s) 1420 and/or the transceiver(s) 1426. For example, the cell DTX/DRX module 1432 may be implemented by a combination of software components (e.g., executed by a DSP or a general processor) and hardware components (e.g., logic gates and circuitry) within the processor(s) 1420 or the transceiver(s) 1426.

The cell DTX/DRX module 1432 may be used for various aspects of the present disclosure, for example, aspects of FIG. 1 through FIG. 12. For example, the cell DTX/DRX module 1432 may be configured to cause the network device 1418 (e.g., a base station) to communicate with a UE according to a non-active serving cell mode during a non-active duration of a serving cell of the network device 1418.

Embodiments contemplated herein include an apparatus comprising means to perform one or more elements of either of the method 1000 and the method 1100. This apparatus may be, for example, an apparatus of a UE (such as a wireless device 1402 that is a UE, as described herein).

Embodiments contemplated herein include one or more non-transitory computer-readable media comprising instructions to cause an electronic device, upon execution of the instructions by one or more processors of the electronic device, to perform one or more elements of either of the method 1000 and the method 1100. This non-transitory computer-readable media may be, for example, a memory of a UE (such as a memory 1406 of a wireless device 1402 that is a UE, as described herein).

Embodiments contemplated herein include an apparatus comprising logic, modules, or circuitry to perform one or more elements of either of the method 1000 and the method 1100. This apparatus may be, for example, an apparatus of a UE (such as a wireless device 1402 that is a UE, as described herein).

Embodiments contemplated herein include an apparatus comprising: one or more processors and one or more computer-readable media comprising instructions that, when executed by the one or more processors, cause the one or more processors to perform one or more elements of either of the method 1000 and the method 1100. This apparatus may be, for example, an apparatus of a UE (such as a wireless device 1402 that is a UE, as described herein).

Embodiments contemplated herein include a signal as described in or related to one or more elements of either of the method 1000 and the method 1100.

Embodiments contemplated herein include a computer program or computer program product comprising instructions, wherein execution of the program by a processor is to cause the processor to carry out one or more elements of either of the method 1000 and the method 1100. The processor may be a processor of a UE (such as a processor(s) 1404 of a wireless device 1402 that is a UE, as described herein). These instructions may be, for example, located in the processor and/or on a memory of the UE (such as a memory 1406 of a wireless device 1402 that is a UE, as described herein).

Embodiments contemplated herein include an apparatus comprising means to perform one or more elements of the method 1200. This apparatus may be, for example, an apparatus of a base station (such as a network device 1418 that is a base station, as described herein).

Embodiments contemplated herein include one or more non-transitory computer-readable media comprising instructions to cause an electronic device, upon execution of the instructions by one or more processors of the electronic device, to perform one or more elements of the method 1200. This non-transitory computer-readable media may be, for example, a memory of a base station (such as a memory 1422 of a network device 1418 that is a base station, as described herein).

Embodiments contemplated herein include an apparatus comprising logic, modules, or circuitry to perform one or more elements of the method 1200. This apparatus may be, for example, an apparatus of a base station (such as a network device 1418 that is a base station, as described herein).

Embodiments contemplated herein include an apparatus comprising: one or more processors and one or more computer-readable media comprising instructions that, when executed by the one or more processors, cause the one or more processors to perform one or more elements of the method 1200. This apparatus may be, for example, an apparatus of a base station (such as a network device 1418 that is a base station, as described herein).

Embodiments contemplated herein include a signal as described in or related to one or more elements of the method 1200.

Embodiments contemplated herein include a computer program or computer program product comprising instructions, wherein execution of the program by a processing element is to cause the processing element to carry out one or more elements of the method 1200. The processor may be a processor of a base station (such as a processor(s) 1420 of a network device 1418 that is a base station, as described herein). These instructions may be, for example, located in the processor and/or on a memory of the base station (such as a memory 1422 of a network device 1418 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving, from a network, first configuration information for a first cell discontinuous transmission (DTX)/discontinuous reception (DRX) pattern used by a first serving cell of the UE, the first configuration information comprising a first periodicity of the first cell DTX/DRX pattern, a first offset for the first cell DTX/DRX pattern, a first active duration length for the for the first cell DTX/DRX pattern, and first UE behavior information defining one or more UE behaviors for a first non-active serving cell mode;
identifying, based on the first periodicity, the first offset, and the first active duration length, a first non-active duration of the first cell DTX/DRX pattern during which the first serving cell is in a first non-active state; and
performing first communication with the network on the first serving cell according to the first non-active serving cell mode during the first non-active duration of the first cell DTX/DRX pattern.

2. The method of claim 1, wherein the first UE behavior information indicates, for a semi-persistent scheduling (SPS) occasion that occurs during the first non-active duration of the first cell DTX/DRX pattern:
whether the UE monitors the SPS occasion for a first physical downlink shared channel (PDSCH) corresponding to an initial SPS transmission; and
whether the UE monitors the SPS occasion for a physical downlink control channel (PDCCH) that indicates an SPS retransmission.

3. The method of claim 2, wherein:
the first UE behavior information indicates that the UE monitors the SPS occasion for the first PDSCH corresponding to the initial SPS transmission, and
the first communication with the network on the first serving cell according to the first non-active serving cell mode comprises receiving the first PDSCH during the SPS occasion.

4. The method of claim 3, further comprising transmitting hybrid automatic repeat request acknowledgment (HARQ-ACK) signaling to the network.

5. The method of claim 3, wherein the first configuration information further identifies an SPS retransmission occasion, and further comprising monitoring the SPS retransmission occasion for the PDCCH that indicates the SPS retransmission.

6. The method of claim 3, wherein the SPS retransmission occasion is a reserved occasion for the SPS retransmission.

7. The method of claim 2, wherein:
the first UE behavior information indicates that the UE monitors the SPS occasion for the PDCCH that indicates the SPS retransmission, and
the first communication with the network on the first serving cell according to the first non-active serving cell mode comprises receiving the PDCCH during the SPS occasion.

8. The method of claim 7, wherein one or more of:
the first communication with the network on the first serving cell according to the first non-active serving cell mode further comprises receiving a second PDSCH as scheduled by the PDCCH; and
the method further comprises transmitting hybrid automatic repeat request acknowledgment (HARQ-ACK) signaling to the network.

9. The method of claim 1, wherein the first UE behavior information indicates, for a configured grant (CG) occasion that occurs during the first non-active duration of the first cell DTX/DRX pattern:
whether the CG occasion is usable by the UE for an initial CG transmission; and
one or more of:
whether the UE monitors the CG occasions for a physical downlink control channel (PDCCH) that indicates a CG retransmission; and
whether the CG occasion is usable by the UE for an autonomous CG retransmission.

10. The method of claim 9, wherein:
the first UE behavior information indicates that the CG occasion is usable by the UE for the initial CG transmission, and
first non-active serving cell mode comprises using the CG occasion for the initial CG transmission; and
further comprising:
stopping a CG timer for a hybrid automatic repeat request (HARQ) process; and
refreshing a HARQ buffer at a beginning of the first non-active duration of the first cell DTX/DRX pattern.

11. The method of claim 10, wherein the first configuration information further identifies a CG retransmission occasion; and further comprising monitoring the CG retransmission occasion for the PDCCH that indicates the CG retransmission.

12. The method of claim 11, wherein the CG retransmission occasion is a reserved occasion for the CG retransmission.

13. The method of claim 9, wherein:
the first UE behavior information indicates that:
the CG occasion is not usable by the UE for the initial CG transmission, and
the UE monitors the CG occasion for the PDCCH that indicates the CG retransmission; and
the first communication with the network on the first serving cell according to the first non-active serving cell mode comprises receiving the PDCCH that indicates the CG retransmission; and
further comprising running a CG timer until a hybrid automatic repeat request (HARQ) buffer is refreshed.

14. The method of claim 9, wherein:
the first UE behavior information indicates that:
the CG occasion is not usable by the UE for the initial CG transmission, and
the CG occasion is usable by the UE for the autonomous CG retransmission; and
first non-active serving cell mode comprises performing the autonomous CG retransmission during the CG occasion prior to a time that a hybrid automatic repeat request (HARQ) buffer is refreshed.

15. The method of claim 1, wherein the first communication with the network on the first serving cell according to the first non-active serving cell mode comprises contention based random access (CBRA) messaging, the CBRA messaging comprising one or more of preamble messaging, random access response (RAR) messaging, and contention resolution messaging.

16. The method of claim 1, wherein the first communication with the network on the first serving cell according to the first non-active serving cell mode comprises contention free random access (CFRA) messaging, the CFRA messaging comprising one or more of preamble messaging, random access response (RAR) messaging, and transmitting a RAR-indicated physical uplink shared channel (PUSCH).

17. The method of claim 1, wherein the first communication with the network on the first serving cell according to the first non-active serving cell mode comprises one or more of paging reception and system information reception.

18. The method of claim 1, wherein the first communication with the network on the first serving cell according to the first non-active serving cell mode comprises one of transmitting a physical uplink shared channel (PUSCH) on the first serving cell as scheduled by a second serving cell and receiving a physical downlink shared channel (PDSCH) on the first serving cell as scheduled by the second serving cell.

19. The method of claim 1, wherein the first communication with the network on the first serving cell according to the first non-active serving cell mode comprises one of a transmission of an aperiodic sounding reference signal (SRS) and an aperiodic channel state information (CSI) message.

20. The method of claim 1, wherein:
the first UE behavior information indicates that one of a semi-persistent sounding reference signal (SRS) and a periodic SRS is to be transmitted during the first non-active duration of the first cell DTX/DRX pattern; and
the first communication with the network on the first serving cell according to the first non-active serving cell mode comprises a transmission of the one of the semi-persistent SRS and the periodic SRS.

21-34. (canceled)
